(19) United States
(12) Patent Application Publication
(10) Pub. No.: US 2011/0283574 A1
(43) Pub. Date: Nov. 24, 2011

(54) LICENSE PLATE ADD ON AND FRAME SURROUND

(76) Inventors: Brad ELLMAN, Oceanside, NY (US); Rita ELLMAN, Oceanside, NY (US)

(21) Appl. No.: 13/102,583

(22) Filed: May 6, 2011

Related U.S. Application Data
(60) Provisional application No. 61/345,752, filed on May 18, 2010.

(51) Int. Cl. B60R 11/00; B60R 13/10

(52) U.S. Cl. 40/209

(57) ABSTRACT

A semi-permanent replaceable license plate add on and frame surround includes a frame composed of rigid or semi-rigid material that is weatherproof, temperature and ultraviolet resistant. It is structured and sized to cover substantially a perimeter of a license plate without substantially covering identifying indicia, and devoid of any structural or supportive properties for the license plate, itself. The surround includes a plurality of attachment devices secured to the frame with permanent or semi-permanent adhesive, structured to removeably attach the frame directly to the license plate or plate surround. The surround further includes a plurality of corresponding attachment devices for securing to the license plate or the plate surround and structured to attach the frame directly to the license plate or the existing plate surround by aligning and press fitting to the plurality of attachment devices. The corresponding attachment devices are removeably attachable to the plurality of attachment devices.

### CROSS REFERENCE TO RELATED APPLICATIONS

The present application claims priority to provisional application Ser. No. 61/345,752, filed on May 18, 2010, the contents of which are incorporated by reference in their entirety herein.

### FIELD OF THE INVENTION

The invention relates to a license plate frame surround and, more particularly, to a semi-permanent replaceable license plate add on and frame surround.

### BACKGROUND

Conventional license plate surrounds require tools for installation. They typically have screw holes that line up with standard plates and car holes. The majority of plate surrounds are advertisements for regional car dealers. They are installed with the new plates when the car is sold and usually have the dealer name on them. They wrap around the plate and have a lip or some kind of channel geometry at the edges. They are generally black and white and not very attractive. There are a few screw-on type surrounds that replace the conventional license plate provided by, for example, the car dealer. They are basically the same structure, but with a saying, logo or graphic design. Once put in place, they are rarely changed until the car is sold or plates changed.

Accordingly, there exists a need in the art to overcome the deficiencies and limitations described hereinabove.

### SUMMARY OF THE INVENTION

In a first aspect of the invention, an apparatus comprises a semi-permanent replaceable license plate add on and frame surround that is detachably removable from a plate surround or plate. In embodiments, the plate surround or plate is retrofitted with the semi-permanent replaceable license plate add on and frame surround. In embodiments, the semi-permanent replaceable license plate add on and frame surround includes a logo, saying or other indicia thereon.

In embodiments, the logo, saying or other indicia can be placed at any location on a first face on the semi-permanent replaceable license plate add on and frame surround. In embodiments, the semi-permanent replaceable license plate add on and frame surround is fixed or adjustable to fit directly over a standard license plate surround or plate. In embodiments, the semi-permanent replaceable license plate add on and frame surround decorates the perimeter of the plate/tag without covering identifying numbers or letters of the plate indicia. In embodiments, the semi-permanent replaceable license plate add on and frame surround is attached using an attachment device. In embodiments, the attachments device is a hook and loop or Dual Lock™ (Dual Lock is a trademark owned by 3M Corporation) configuration. In embodiments, attachment device is placed at a plurality of different locations.

In another aspect of the invention, a semi-permanent replaceable license plate add on and frame surround comprises a frame composed of rigid or semi-rigid material that is weatherproof, temperature resistant and ultraviolet resistant, and which is structured and sized to cover substantially a perimeter of a license plate without substantially covering identifying indicia, and which is devoid of any structural or supportive properties for the license plate, itself. The surround further comprises a plurality of attachment devices secured to the frame with permanent or semi-permanent adhesive, on a side that faces the license plate. The plurality of attachment devices are structured to removeably attach the frame directly to the license plate or an existing plate surround. The surround further comprises a plurality of corresponding attachment devices for securing to the license plate or the existing plate surround and structured to attach the frame directly to the license plate or the existing plate surround by aligning and press fitting to the plurality of attachment devices. The plurality of corresponding attachment devices are removeably attachable to the plurality of attachment devices.

In embodiments, the plurality of attachment devices are provided on corners of the frame. In embodiments, the plurality of attachment devices are provided on locations along a perimeter on each side of the frame. In embodiments, the plurality of attachment devices and the plurality of corresponding attachment devices are hook and loop devices, wherein one of the hook and the loop are provided on the frame and the other of the hook and loop is for placing on the license plate or existing plate surround. In embodiments, the one of the hook and the loop devices are attached to the frame by adhesive. In embodiments, the plurality of attachment devices are rectangles, squares, press fit dots, or appropriately positioned (adjoining materials) or magnets so that North Pole/South Pole sides can attract. In embodiments, the plurality of attachment devices and the plurality of corresponding attachment devices are attached with permanent or semi-permanent or removeable adhesive. In embodiments, the frame is made of plastic such as polyethylene, polypropylene, Polyvinyl chloride (PVC), polystyrene, recycled or virgin materials and combination materials such as paper pulp-plastic, coated paper, paperboard product, aluminum or light metal alloy. In embodiments, the frame is pliable and bends to fit or move with washing, handling or road conditions. In embodiments, the frame is structured so as to not be in direct contact with a painted finish of a vehicle. In embodiments, the frame has a shape that covers only a perimeter of the license plate or the existing plate surround and includes at least one of rounded edges, sides, tabs and screw holes. The attachment devices are provided on the backside of the frame such that the attachment devices are not seen when the frame is installed on an existing license plate or license plate surround. Thus, the frame of the present invention appears to be “floating” on the license plate or license plate surround.

In another aspect of the invention, a semi-permanent replaceable license plate add on and frame surround, comprises: a frame composed of rigid or semi-rigid material that is weatherproof, temperature resistant and ultraviolet resistant, and which is structured and sized to cover substantially a perimeter of a license plate and which is devoid of any structural or supportive properties for the license plate, itself; a logo or other indicia on portions of the frame; and a plurality of attachment devices comprising two sided tape or integral non-permanent adhesive secured to the frame, on a side that faces the license plate, the plurality of attachment devices being structured to removeably attach the frame directly to the license plate or an existing plate surround. The plurality of attachment devices are provided on one of corners of the frame and on locations along a perimeter on each side of the frame. The frame is made of plastic such as polyethylene, polypropylene, polyvinyl chloride (PVC), polystyrene, recycled or virgin materials and combination materials such as paper pulp-plastic, coated paper, paperboard product, aluminum or light metal alloy. The frame is pliable and bends to fit or move with washing, handling or road conditions. The frame is structured so as to not be in direct contact with a painted finish of a vehicle. The frame has a shape that includes at least one of rounded edges, sides, tabs and screw holes.

### BRIEF DESCRIPTION OF THE SEVERAL VIEWS OF THE DRAWINGS

The present invention is described in the detailed description, which follows in reference to the noted plurality of drawings by way of non-limiting examples of exemplary embodiments of the present invention.

FIG. 1 shows a conventional license plate surround;

FIG. 2 shows a conventional license plate surround with a semi-permanent replaceable license plate add on and frame surround in accordance with aspects of the invention;

FIG. 3 shows a conventional license plate surround with attachment devices thereon for attaching with the semi-permanent replaceable license plate add on and frame surround in accordance with aspects of the invention;

FIG. 4 shows a front side of the semi-permanent replaceable license plate add on and frame surround in accordance with aspects of the invention;

FIG. 5 shows a rear side of the semi-permanent replaceable license plate add on and frame surround with attachment devices thereon in accordance with aspects of the invention;

FIG. 6 shows the semi-permanent replaceable license plate add on and frame surround with attachment devices being attached to or removed from the conventional license plate surround in accordance with aspects of the invention; and

FIGS. 7-9 show the semi-permanent replaceable license plate add on and license plate surround at various stages of attachment and/or removal in accordance with aspects of the invention.

### DETAILED DESCRIPTION

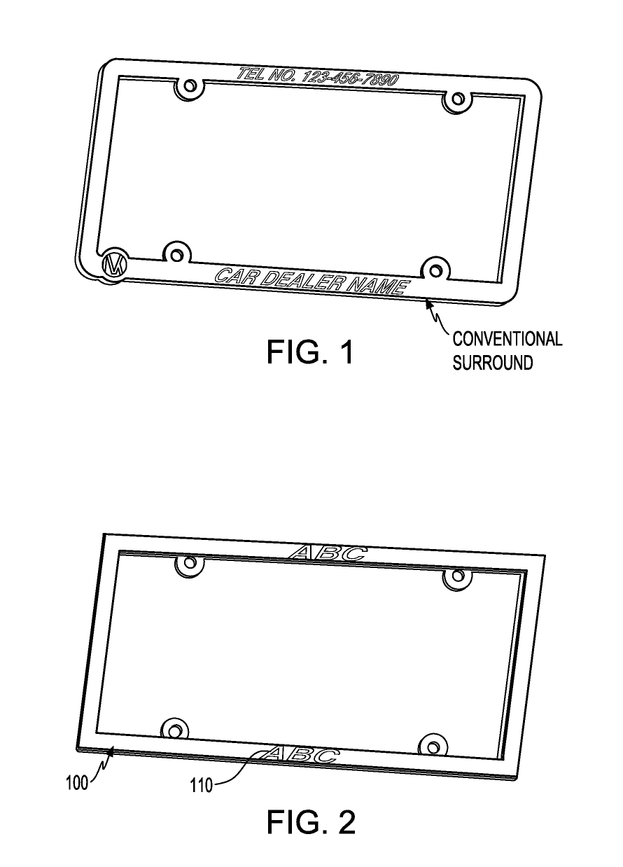

The invention relates to a license plate frame surround and, more particularly, to a semi-permanent replaceable license plate add on and frame surround. In embodiments, the present invention can be attached to and removed from a conventional license plate and/or license plate surround. A conventional license plate surround is shown, for example, in FIG. 1. It should be understood by those of skill in the art that the semi-permanent replaceable license plate add on and frame surround of the present invention can be used with other license plate surrounds or directly on the license plate itself.

In embodiments, as shown in FIG. 2, a conventional license plate surround can be retrofitted with the semi-permanent replaceable license plate add on and frame surround 100 in accordance with aspects of the invention. The semi-permanent replaceable license plate add on and frame surround 100 can include a logo, saying or other indicia thereon, as represented by reference numeral 110. The logo, saying or other indicia 110 can be placed at any location on the semi-permanent replaceable license plate add on and frame surround 100.

In embodiments, the semi-permanent replaceable license plate add on and frame surround 100 is sized to fit directly over a standard license plate surround or license plate. It decorates the perimeter of the plate with a saying or logo or design without covering the identifying numbers or letters of the plate. It will cover, for example, the dealer surround and add color, a logo, a design or a slogan to a plain surround. In embodiments, it has no structural or supportive properties to the plate itself, and can be attached directly to the plate or existing surround using a convenient type of attachment device such as, for example, a hook and loop fabric, semi permanent adhesives or two sided tape, for example.

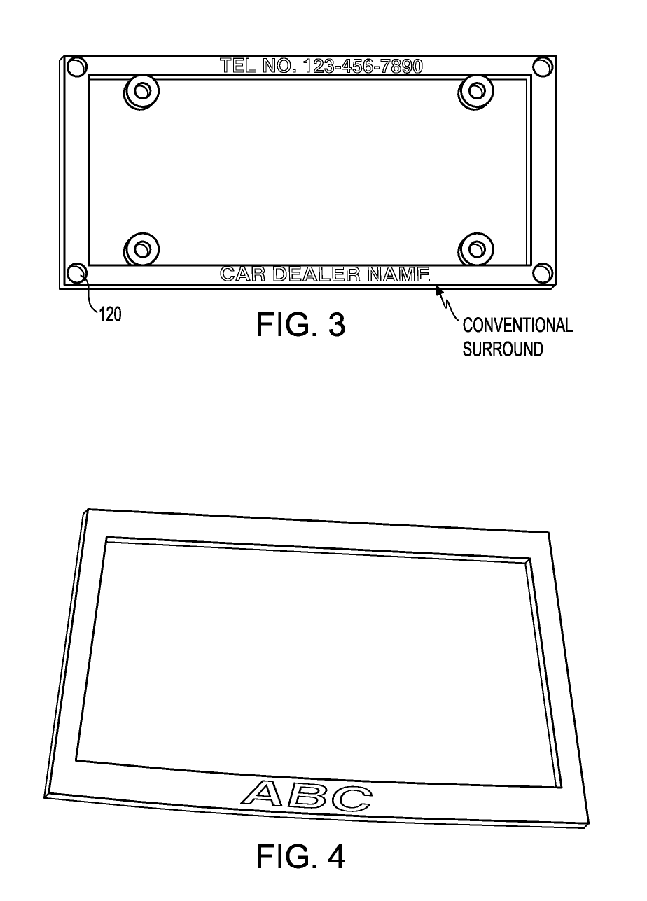

FIG. 3 shows a conventional license plate with attachment devices thereon for attaching with the semi-permanent replaceable license plate add on and frame surround in accordance with aspects of the invention. In the embodiment shown, the attachment devices 120 can be placed at the corners of the conventional license plate; although other locations are also contemplated by the invention such as, for example, along the perimeter on each side. In embodiments, the attachment device 120 can be a hook and loop, for example Velcro™, press fit dots, dual lock, or other dimensional configuration, or appropriately positioned magnets so that the North Pole/South Pole sides can attract. The attachment device 120 can be secured to the conventional license plate with any type of permanent or semi-permanent or removeable adhesive used on plastics, metal and/or fabrics, known to those of skill in the art. In embodiments, the hook and loop can be attached by two sided tape, aggressive adhesive backing common to some types of hook and loop or adhesive dots or strips for example. In embodiments, the attachment device 120 is removable.

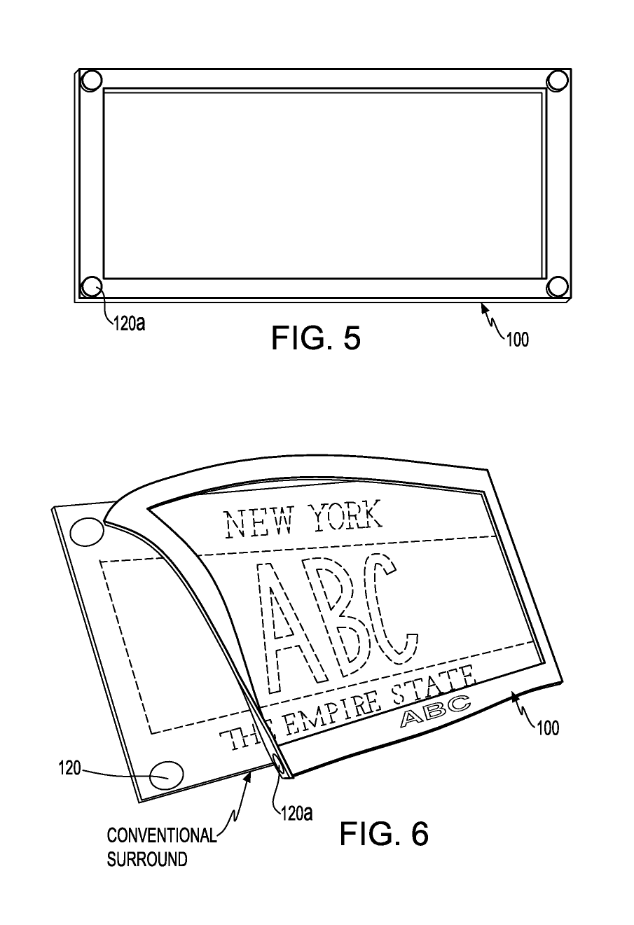

FIG. 4 shows a front side of the semi-permanent replaceable license plate add on and frame surround in accordance with aspects of the invention. FIG. 5 shows a rear side of the semi-permanent replaceable license plate add on and frame surround 100 with attachment devices 120a thereon in accordance with aspects of the invention. The attachment devices 120a can be a hook and loop (Velcro™) dots or other dimensional configuration, or magnets or other attachment devices as discussed herein with reference to, for example, the attachment devices 120. The attachment devices 120a can be secured to the semi-permanent replaceable license plate add on and frame surround 100 with any type of permanent or semi-permanent adhesive used on plastics, metal and/or fabrics, known to those of skill in the art. In embodiments, the attachment devices 120a can be attached by two sided tape or can be an integral part of the surround 100, for example. The attachment devices 120a are provided on the backside of the frame 100 such that the attachment devices 120a are not seen when the frame 100 is installed on an existing license plate or license plate surround. Thus, the frame 100 of the present invention appears to be “floating” on the license plate or license plate surround.

In embodiments, the attachment device 120a is removable and is used to fasten to the attachment devices 120 on the conventional license plate surround. In embodiments, the attachment devices 120a can be a two sided tape or other known attachment, which would eliminate the need for the attachment devices 120 on the conventional surround. The attachment devices 120a can be placed at the corners of the semi-permanent replaceable license plate add on and frame surround 100; although other locations are also contemplated by the invention such as, for example, along the perimeter on each side or other alignments with the attachment devices 120.

FIG. 6 shows a the semi-permanent replaceable license plate add on and frame surround 100 with attachment devices being attached to or removed from the conventional license plate surround in accordance with aspects of the invention. Unlike a permanent surround, the semi-permanent replaceable license plate add on and frame surround 100 requires no screws and no tools to adhere to or remove from the plate or surround. It can be easily changed/exchanged by pulling off and putting on the new semi-permanent replaceable license plate add on and frame surround 100 by engaging and disengaging the hook and loop or other attachment device. Usually, this can be done in less than a minute by the consumer.

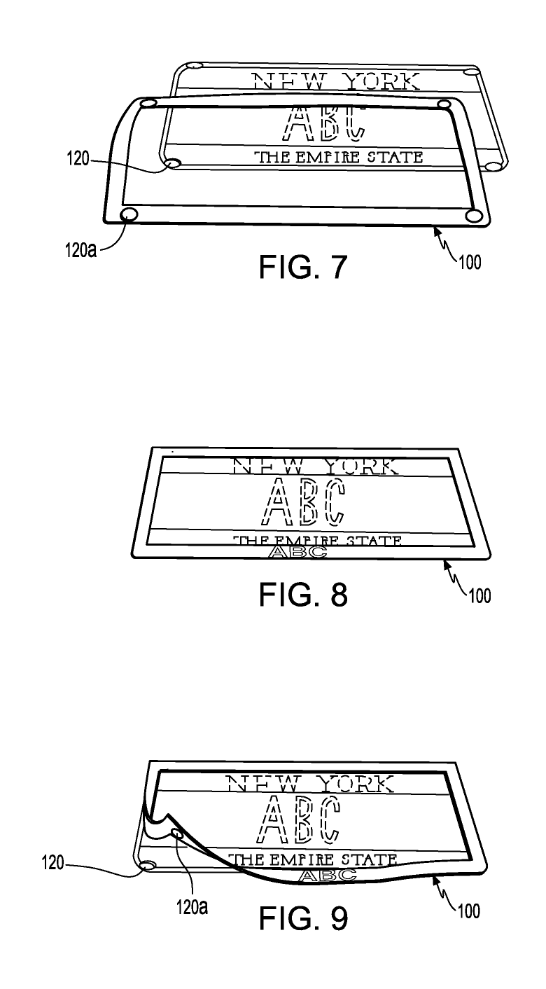

FIGS. 7-9 show the semi-permanent replaceable license plate add on and license plate surround at various stages of attachment and/or removal in accordance with aspects of the invention. In FIG. 7, the semi-permanent replaceable license plate add on and frame surround 100 is shown with a license plate. Both the license plate and the semi-permanent replaceable license plate add on and frame surround 100 have attachment devices 120, 120a thereon. In this representation, the semi-permanent replaceable license plate add on and frame surround 100 is shown at its rear side. In FIG. 8, the semi-permanent replaceable license plate add on and frame surround 100 is attached directly to the conventional license plate. In FIG. 9, the semi-permanent replaceable license plate add on and frame surround 100 is shown to be attached to or removed from the license plate.

In embodiments, the semi-permanent replaceable license plate add on and frame surround 100 is made out of material that is weather proof, resistant to temperature changes and UV resistant. For example, the semi-permanent replaceable license plate add on and frame surround 100 can be made out of plastics that meet the criteria such as polyethylene, polypropylene, PVC, polystyrene, recycled or virgin materials and combination materials such as paper pulp-plastic, coated paper, paperboard product, aluminum or other light metal or metal alloy. The semi-permanent replaceable license plate add on and frame surround 100 comes in a variety of colors and styles with simple phrases and/or decorative designs. The semi permanent replaceable license plate add on can be rigid or semi rigid. It is not completely rigid. In embodiments, it is somewhat pliable and can bend a bit to fit or move with aggressive washing, handling or road conditions. Because there are no tools, bolts, clips or screws required to apply or remove the semi-permanent replaceable license plate add on and frame surround 100 the customer will be more likely to make changes to the plate surround than if the surround were permanently fastened.

It is preferable that the semi-permanent replaceable license plate add on and frame surround 100 is not in direct contact with the painted finish of the car. Also, as for any of the embodiments of the present invention, the semi-permanent replaceable license plate add on and frame surround 100 is not limited to a rectangular shape. The semi-permanent replaceable license plate add on and frame surround 100 can include any shape that would cover the perimeter of the license plate and/or frame such as, for example, rounded edges, square edges sides, tabs, screw holes, etc.

The semi-permanent replaceable license plate add on and frame surround 100 package will contain instructions in text and pictures to instruct the user on how to adhere the product to their plate or surround. For example, place the attachment devices 120 on a conventional surround at predetermined locations, and place the semi-permanent replaceable license plate add on and frame surround 100 over the conventional surround, aligning the attachments devices 120 and 120a. thereafter, press to secure. The reverse can also be provided in the instructions to remove the semi-permanent replaceable license plate add on and frame surround 100.

The product will be packaged as Plate Partner. It can have a stylized logo and unique identifier to confirm it is the genuine product. It will have a package to protect the product during shipping and display. The product will be POP (Point of Purchase) ready and easily displayed at retail.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims. It should also be understood that the embodiments and aspects described herein can be combined in any combination.

What is claimed:

1. An apparatus comprising a semi-permanent replaceable license plate add on and frame surround that is detachably removable from a plate surround or plate.

2. The apparatus of claim 1, wherein the plate surround or the plate is retrofitted with the semi-permanent replaceable license plate add on and frame surround.

3. The apparatus of claim 1, wherein the semi-permanent replaceable license plate add on and frame surround includes a logo, saying or other indicia thereon.

4. The apparatus of claim 3, wherein the logo, saying or other indicia can be placed at any location on a first face on the semi-permanent replaceable license plate add on and frame surround.

5. The apparatus of claim 1, wherein the semi-permanent replaceable license plate add on and frame surround is fixed or adjustable to fit directly over a standard license plate surround or the plate.

6. The apparatus of claim 1, wherein the semi-permanent replaceable license plate add on and frame surround decorates the perimeter of the plate without covering identifying numbers or letters of indicia on the plate.

7. The apparatus of claim 1, wherein the semi-permanent replaceable license plate add on and frame surround is attached using an attachment device.

8. The apparatus of claim 7, wherein the attachment device is a hook and loop configuration.

9. The apparatus of claim 1, wherein the attachment device is placed at a plurality of different locations.

10. A semi-permanent replaceable license plate add on and frame surround, comprising:
a frame composed of rigid or semi-rigid material that is weatherproof, temperature resistant and ultraviolet resistant, and which is structured and sized to cover substantially a perimeter of a license plate without substantially covering identifying indicia thereon, and which is devoid of any structural or supportive properties for the license plate, itself;
a plurality of attachment devices secured to the frame with permanent or semi-permanent adhesive, on a side that faces the license plate, the plurality of attachment devices being structured to removeably attach the frame directly to the license plate or a plate surround; and
a plurality of corresponding attachment devices for securing to the license plate or the plate surround and structured to attach the frame directly to the license plate or the plate surround by aligning and press fitting to the plurality of attachment devices,
wherein the plurality of corresponding attachment devices are removeably attachable to the plurality of attachment devices.

11. The semi-permanent replaceable license plate add on and frame surround of claim 10, wherein the plurality of attachment devices are provided on corners of the frame.

12. The semi-permanent replaceable license plate add on and frame surround of claim 10, wherein the plurality of attachment devices are provided on locations along a perimeter on each side of the frame.

13. The semi-permanent replaceable license plate add on and frame surround of claim 10, wherein:
the plurality of attachment devices and the plurality of corresponding attachment devices are hook and loop devices, wherein one of the hook and the loop are provided on the frame and the other of the hook and loop is for placing on the license plate or the plate surround; and
the one of the hook and the loop devices are attached to the frame by adhesive.

14. The semi-permanent replaceable license plate add on and frame surround of claim 10, wherein the plurality of attachment devices are press fit dots, or appropriately positioned magnets so that north pole/south pole sides can attract.

15. The semi-permanent replaceable license plate add on and frame surround of claim 10, wherein the plurality of attachment devices and the plurality of corresponding attachment devices are attached with permanent or semi-permanent or removeable adhesive.

16. The semi-permanent replaceable license plate add on and frame surround of claim 10, wherein the frame is made of plastic such as polyethylene, polypropylene, polyvinyl chloride (PVC), polystyrene, recycled or virgin materials and combination materials such as paper pulp-plastic, coated paper, paperboard product, aluminum or light metal alloy.

17. The semi-permanent replaceable license plate add on and frame surround of claim 10, wherein the frame is pliable and bends to fit or move with washing, handling or road conditions.

18. The semi-permanent replaceable license plate add on and frame surround of claim 10, wherein the frame is structured so as to not be in direct contact with a painted finish of a vehicle.

19. The semi-permanent replaceable license plate add on and frame surround of claim 10, wherein the frame has a shape that covers only a perimeter of the license plate or the plate surround and includes at least one of rounded edges, square edges, sides, tabs and screw holes.

20. A semi-permanent replaceable license plate add on and frame surround, comprising:
a frame composed of rigid or semi-rigid material that is weatherproof, temperature resistant and ultraviolet resistant, and which is structured and sized to cover substantially a perimeter of a license plate and which is devoid of any structural or supportive properties for the license plate, itself;
a logo or other indicia on portions of the frame; and
a plurality of attachment devices comprising two sided tape or integral non-permanent adhesive secured to the frame, on a side that faces the license plate, the plurality of attachment devices being structured to removeably attach the frame directly to the license plate or an existing plate surround, wherein:
the plurality of attachment devices are provided on one of corners of the frame and on locations along a perimeter on each side of the frame;
the frame is made of plastic such as polyethylene, polypropylene, polyvinyl chloride (PVC), polystyrene, recycled or virgin materials and combination materials such as paper pulp-plastic, coated paper, paperboard product, aluminum or light metal alloy;
the frame is pliable and bends to fit or move with washing, handling or road conditions;
the frame is structured so as to not be in direct contact with a painted finish of a vehicle; and
the frame has a shape that includes at least one of rounded edges, square edges, sides, tabs and screw holes.
